(19) United States
(12) Patent Application Publication
(10) Pub. No.: US 2026/0003098 A1
(43) Pub. Date: Jan. 1, 2026

(54) POROSITY AND PERMEABILITY MODEL METHOD AND SYSTEM FOR DELTA FRONT CHANNEL BASED ON SPATIAL TREND CONSTRAINT

(71) Applicant: Yangtze University, Jingzhou (CN)

(72) Inventors: Xianghui ZHANG, Jingzhou (CN); Changmin ZHANG, Jingzhou (CN); Shaohua LI, Jingzhou (CN); Rui ZHU, Jingzhou (CN); Jiale LIU, Jingzhou (CN)

(73) Assignee: Yangtze University, Jingzhou (CN)

(21) Appl. No.: 18/966,800

(22) Filed: Dec. 3, 2024

(30) Foreign Application Priority Data
Jun. 26, 2024 (CN) 202410834526.3

(51) Int. Cl. G01V 20/00

(52) U.S. Cl. CPC G01V 20/00

(57) ABSTRACT

The present invention discloses a porosity and permeability model method and system for a delta front channel based on a spatial trend constraint. The method includes the following steps: establishing a lateral trend body in a single-stage channel; establishing a pendant trend body in a single-stage channel; setting different weightings for the lateral trend body and the pendant trend body respectively for multiple times to obtain a fusion trend body corresponding to each weighted fusion; and based on porosity data and permeability data in the drilling data, and with all different fusion trend bodies as modeling constraint conditions, obtaining a porosity model and a permeability model of the underwater distributary channel in the study area corresponding to each weighted fusion, respectively. Therefore, internal heterogeneity characteristics of the underwater distributary channel at different positions can be characterized based on a modeling process of multi-directional trend fusion constraints.

### CROSS-REFERENCE TO RELATED APPLICATIONS

The application claims priority to Chinese patent application No. 202410834526.3, filed on Jun. 26, 2024, the entire contents of which are incorporated herein by reference.

### TECHNICAL FIELD

The present invention relates to the technical field of reservoir description, and in particular, to a porosity and permeability model method and system for a delta front channel based on a spatial trend constraint.

### BACKGROUND

The delta front of braided rivers is an important oil and gas reservoir and a favorable area for oil and gas exploration in terrestrial sedimentary basins. The delta front of braided rivers has complex sedimentary genesis characteristics. In such delta front, sand bodies of underwater distributary channels with different genesis and different stages in the same period cut and stack each other, resulting in differences in physical properties, complex reservoir structure, high heterogeneity, and difficulty in excavation of remaining oil. This has led to an increasing study interest in braided river delta reservoirs internationally.

Previous studies have conducted extensive work on modeling the braided river delta reservoirs by adopting methods such as sequential indicator simulation, deterministic modeling, a combination of deterministic modeling and sequential Gaussian simulation, marked point processes, and multi-point geostatistics. Meanwhile, a geological modeling process is collaboratively constrained by using seismic inversion data, sediment forward modeling data, two-dimensional trend surface data, etc. However, in terms of characterizing the change rules of internal physical properties in different directions of different channels and single-stage channels, the existing modeling strategies or constraint data lack such applications.

### SUMMARY

The present invention provides a porosity and permeability model method and system for a delta front channel based on a spatial trend constraint. According to the present invention, internal heterogeneity characteristics of an underwater distributary channel at different positions in delta front subfacies can be characterized based on a modeling process of multi-directional trend fusion constraints, which provides a scientific basis for the distribution and development decision of remaining oil in channel facies reservoirs of braided river delta fronts.

A first aspect provides a porosity and permeability model method for a delta front channel based on a spatial trend constraint, including the following steps:
transmitting drilling data of an underwater distributary channel in a study area to a PETREL modeling software, and establishing a channel facies model based on the drilling data;
establishing a lateral trend body of the underwater distributary channel in the study area by using an internal lateral trend constraint of a single-stage channel in the channel facies model;
establishing a pendant trend body of the underwater distributary channel in the study area by using an internal pendant trend constraint of the single-stage channel in the channel facies model;
setting different weightings for the lateral trend body and the pendant trend body respectively for multiple times to obtain a fusion trend body corresponding to each weighted fusion; and
based on porosity data and permeability data in the drilling data, and with all different fusion trend bodies as modeling constraint conditions, obtaining a porosity model and a permeability model of the underwater distributary channel in the study area corresponding to each weighted fusion, respectively.

According to the first aspect, in a first possible implementation of the first aspect, the step of “establishing a channel facies model based on the drilling data” specifically includes:
based on microfacies data of a delta front sedimentary system in the drilling data, establishing the channel facies model in the study area by using a Fluvsim algorithm.

According to the first aspect, in a second possible implementation of the first aspect, the step of “establishing a lateral trend body of the underwater distributary channel in the study area by using an internal lateral trend constraint of a single-stage channel in the channel facies model” specifically includes:
obtaining an initial lateral trend body by using an internal lateral trend of the single-stage channel in the channel facies model, where the internal lateral trend of the channel is defined as a rule of gradually fining grain sizes of sand bodies and decreasing physical properties from a center to two sides of the channel; and
normalizing the initial lateral trend body to the lateral trend body of the underwater distributary channel in the study area within a range of [0-1].

According to the first aspect, in a third possible implementation of the first aspect, the step of “establishing a pendant trend body of the underwater distributary channel in the study area by using an internal pendant trend constraint of a single-stage channel in the channel facies model” specifically includes:
obtaining an initial pendant trend body by using the internal pendant trend of the single-stage channel in the channel facies model, where the internal pendant trend of the channel is defined as a rule of gradually fining grain sizes and decreasing physical properties from a bottom to a top of the channel;
normalizing the initial pendant trend body to the pendant trend body of the underwater distributary channel in the study area within a range of [0-1].

According to the first aspect, in a fourth possible implementation of the first aspect, the step of “setting different weightings for the lateral trend body and the pendant trend body respectively for multiple times to obtain a fusion trend body corresponding to each weighted fusion” specifically includes:
setting a weighting α for the lateral trend body Pᵢⱼₖ, and setting a weighting β for the pendant trend body Vᵢⱼₖ, a weighted calculation method for the fusion trend body ωᵢⱼₖ being as follows:

$${ω}_{ijk} = α {P}_{ijk} + {BV}_{ijk} ; where$$

$$0 \leq α \leq 1 , 0 \leq β \leq 1 , α + β = 1 , 0 \leq {ω}_{ijk} < 1 ;$$

where
i is positions of grid points in an east-west direction of the trend bodies; j is positions of grid points in a south-north direction of the trend bodies, and k is positions of grid points in a pendant direction of the trend bodies.

According to the first aspect, in a fifth possible implementation of the first aspect, the step of “based on porosity data and permeability data in the drilling data, and with all different fusion trend bodies as modeling constraint conditions, obtaining a porosity model and a permeability model of the underwater distributary channel in the study area corresponding to each weighted fusion, respectively” specifically includes:
based on the porosity data in the drilling data, and with all different fusion trend bodies as the modeling constraint conditions, establishing the porosity model of the underwater distributary channel in the study area corresponding to each weighted fusion by using a sequential Gaussian stimulation method; and
based on a positive correlation relationship between the porosity data and the permeability data in the drilling data, and with all different fusion trend bodies and the porosity model as the modeling constraint conditions, establishing the permeability model of the underwater distributary channel in the study area corresponding to each weighted fusion by using the sequential Gaussian stimulation method.

According to the first aspect, in a sixth possible implementation of the first aspect, after the step of “setting different weightings for the lateral trend body and the pendant trend body respectively for multiple times to obtain a fusion trend body corresponding to each weighted fusion”, the method specifically includes:
counting a probability distribution of sand body development and an average probability of sand body development of all grids in the fusion trend body corresponding to each weighted fusion to obtain an influence trend of different weightings on the probability distribution of sand body development and the average probability of sand body development.

According to the first aspect, in a seventh possible implementation of the first aspect, after the step of “based on porosity data and permeability data in the drilling data, and with all different fusion trend bodies as modeling constraint conditions, obtaining a porosity model and a permeability model of the underwater distributary channel in the study area corresponding to each weighted fusion, respectively”, the method specifically includes:
calculating an average porosity of the porosity model of the underwater distributary channel in the study area corresponding to each weighted fusion, and calculating an average permeability of the permeability model of the underwater distributary channel in the study area corresponding to each weighted fusion so as to obtain an influence trend of different weightings on the average porosity and the average permeability, respectively.

A second aspect provides a porosity and permeability model system for a delta front channel based on a spatial trend constraint, including:
a data acquisition module, configured to transmit drilling data of an underwater distributary channel in a study area to a PETREL modeling software and establish a channel facies model based on the drilling data;
a lateral trend module in communication connection with the data acquisition module, configured to establish a lateral trend body of the underwater distributary channel in the study area by using a lateral trend constraint of a channel in the channel facies model;
a pendant trend module in communication connection with the data acquisition module, configured to establish a pendant trend body of the underwater distributary channel in the study area by using an internal pendant trend constraint of the single-stage channel in the channel facies model;
a fusion module in communication connection with the lateral trend module and the pendant trend module, configured to set different weightings for the lateral trend body and the pendant trend body respectively for multiple times to obtain a fusion trend body corresponding to each weighted fusion; and
a porosity and permeability construction module in communication connection with the data acquisition module and the fusion module, configured to: based on porosity data and permeability data in the drilling data, and with all different fusion trend bodies as modeling constraint conditions, obtain a porosity model and a permeability model of the underwater distributary channel in the study area corresponding to each weighted fusion, respectively.

A third aspect provides a computer-readable storage medium having a computer program stored thereon, where the computer program, when executed by a processor, implements the porosity and permeability model method for a delta front channel based on a spatial trend constraint described above.

Compared to the prior art, the present invention has the following advantage: internal heterogeneity characteristics of an underwater distributary channel at different positions in delta front subfacies can be characterized based on a modeling process of multi-directional trend fusion constraints, which provides a scientific basis for the distribution and development decision of remaining oil in channel facies reservoirs of braided river delta fronts.

### BRIEF DESCRIPTION OF THE DRAWINGS

FIG. 1 is a flowchart of a porosity and permeability model method for a delta front channel based on a directional trend constraint according to the present invention;

FIG. 2 shows a channel facies model for a study area with a sandstone-to-stratum ratio of 90.5% established by the present invention;

FIG. 3 is a schematic diagram of an internal lateral trend body of an underwater distributary channel according to the present invention;

FIG. 4 is a schematic diagram of an internal pendant trend body of the underwater distributary channel according to the present invention;

FIG. 5 is a schematic diagram of fusion trend bodies under different weights established by the present invention;

FIG. 6 is a schematic diagram of a cross section of the fusion trend bodies under different weights established by the present invention;

FIG. 7 is a schematic diagram of probability value changes of sand body development at the same grid position for the lateral trend body, the pendant trend body, and the fusion trend bodies established by the present invention;

FIG. 8 is a schematic diagram of a porosity model established based on a fusion trend body constraint according to the present invention;

FIG. 9 is a schematic diagram of a cross section of the porosity model established based on the fusion trend body constraint according to the present invention;

FIG. 10 is a schematic diagram of a through-well cross section of the porosity model established based on a fusion trend body constraint with both lateral and pendant weightings being 0.5;

FIG. 11 is a schematic diagram of a positive correlation relationship between porosity data and permeability data of a study area according to the present invention;

FIG. 12 is a schematic diagram of a permeability model established based on the fusion trend body constraint according to the present invention;

FIG. 13 is a schematic diagram of the probability distribution of sand body development in a fusion probability body at different weightings according to the present invention; and

FIG. 14 is a schematic diagram of an influence of different weightings on an average porosity and an average permeability in the fusion probability body according to the present invention.

### DETAILED DESCRIPTION OF THE EMBODIMENTS

Herein, examples of the present invention will be illustrated in the accompanying drawings by referring in detail to specific embodiments of the present invention. Although the present invention will be described in conjunction with specific embodiments, it will be understood that it is not intended to limit the present invention thereto. On the contrary, it is intended to cover the changes, modifications, and equivalents included within the spirit and scope of the present invention as defined by the appended claims. It should be noted that the method steps described herein may be implemented by any functional block or functional arrangement, and any functional block or functional arrangement may be implemented as a physical entity, or a logical entity, or a combination of both.

In order to provide a better understanding of the present invention for those skilled in the art, the present invention will be described below in detail with reference to the accompanying drawings and the specific embodiments:

Note: the instance to be introduced below is merely a specific example and is not intended to be a limitation on the fact that the embodiments of the present invention must be specific steps, values, conditions, data, sequences, etc. presented below. Those skilled in the art can apply the concepts of the present invention by reading this specification to construct further embodiments not mentioned herein.

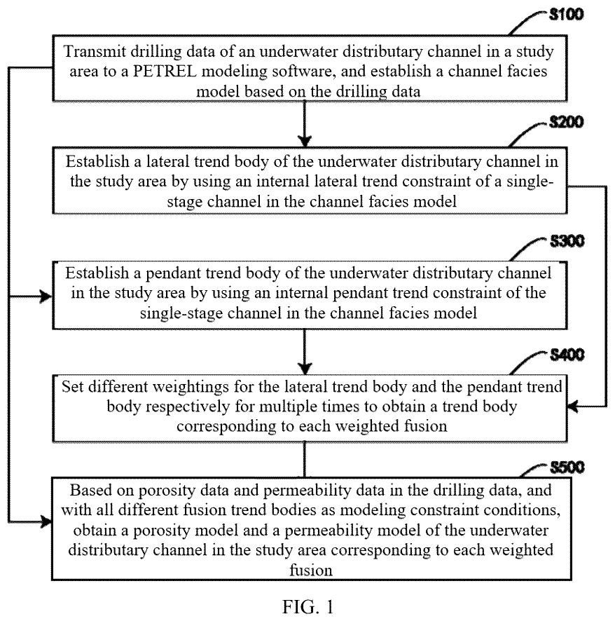

As shown in FIG. 1, an embodiment of the present invention provides a porosity and permeability model method for a delta front channel based on a spatial trend constraint, including the following steps:
S100, transmitting drilling data of an underwater distributary channel in a study area to a PETREL modeling software, and establishing a channel facies model based on the drilling data;
S200, establishing a lateral trend body of the underwater distributary channel in the study area by using an internal lateral trend constraint of a single-stage channel in the channel facies model;
S300, establishing a pendant trend body of the underwater distributary channel in the study area by using an internal pendant trend constraint of the single-stage channel in the channel facies model;
S400, setting different weightings for the lateral trend body and the pendant trend body respectively for multiple times to obtain a fusion trend body corresponding to each weighted fusion; and
S500, based on porosity data and permeability data in the drilling data, and with all different fusion trend bodies as modeling constraint conditions, obtaining a porosity model and a permeability model of the underwater distributary channel in the study area corresponding to each weighted fusion, respectively.

Specifically, in this embodiment, previous studies on the heterogeneity of reservoirs and the distribution rules of sand bodies for the braided river delta fronts have improved the understanding of internal development rules of underwater distributary channels. However, in a traditional process of constructing delta physical property models, methods such as sequential indicator simulation, deterministic modeling, a combination of deterministic modeling and sequential Gaussian simulation, marked point processes, and multi-point geostatistical modeling have been adopted. The limitations of the above-mentioned algorithms are reflected in certain challenges to identify the centerline and boundary positions of the underwater distributary channels, leading to a significant difficulty in establishing internal trend bodies of single-stage channels. Generally, during the use of these algorithms, seismic inversion data, sediment forward modeling, or two-dimensional planar trend surfaces are adopted to constraint models. Results of the models characterize that the rules of internal changes in different directions of different channels and single-stage channels are influenced by the accuracy of constrain data. Therefore, in view of the above problems, according to the present invention, internal heterogeneity characteristics of an underwater distributary channel at different positions in delta front subfacies can be characterized based on a modeling process of multi-directional trend fusion constraints, which provides a scientific basis for the distribution and development decision of remaining oil in channel facies reservoirs of braided river delta fronts.

Preferably, in another embodiment of the present application, the step of “S100, establishing a channel facies model based on the drilling data” specifically includes:
based on microfacies data of a delta front sedimentary system in the drilling data, establishing the channel facies model in the study area by using a Fluvsim algorithm.

Specifically, in this embodiment, the Fluvsim algorithm is a simulation method proposed by Deutsch for establishing complex channels, also known as the “Target-Based Simulation Method”. This modeling method takes a target object as a simulation unit, mainly describes the spatial distribution of various discrete geological features, and is capable of accurately depicting the geometric morphology of channels.

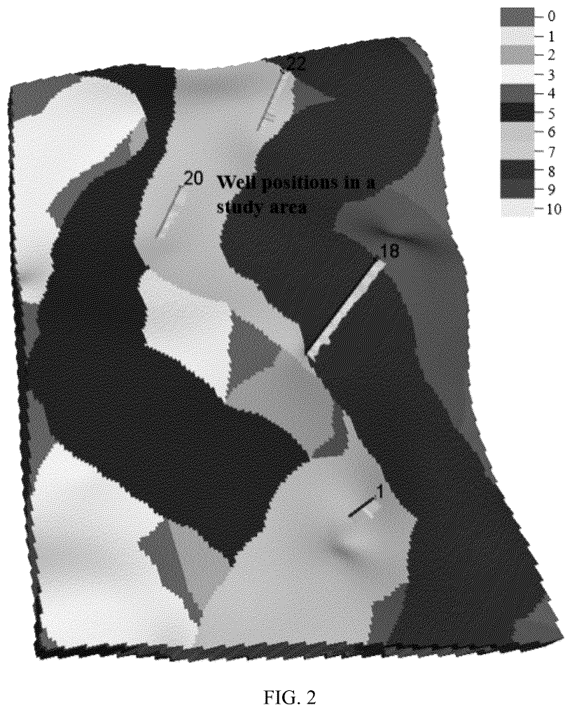

The sandstone-to-stratum ratio data in the microfacies data was obtained based on a combination of logging interpretation data and core observation information acquired during underground drilling of oil and gas fields. A target-based method was adopted to establish a channel facies model for a study area with a sandstone-to-stratum ratio of 90.5%, including 90.5% of an underwater distributary channel and 9.5% of interchannel mud, specifically as shown in FIG. 2. In FIG. 2, labels 1-10 are stage 1-10 channels; 0 is background facies mud; and labels 22, 20, 18, and 1 represent well positions.

Preferably, in another embodiment of the present application, the step of “S200, establishing a lateral trend body of the underwater distributary channel in the study area by using an internal lateral trend constraint of a single-stage channel in the channel facies model” specifically includes:
S210, obtaining an initial lateral trend body by using an internal lateral trend of the single-stage channel in the channel facies model, where the internal lateral trend of the channel is defined as a rule of gradually fining grain sizes of sand bodies and decreasing physical properties from a center to two sides of the channel; and
S220, normalizing the initial lateral trend body to the lateral trend body of the underwater distributary channel in the study area within a range of [0-1].

Specifically, in this embodiment, according to the geological rules and the results of previous geological studies, it is known that within the single-stage channel there exists a rule of gradually fining grain sizes of sand bodies and decreasing physical properties from a center to two sides of the channel in a lateral direction. Based on the above geological understanding, a probability body capable of characterizing the internal lateral trend of a single-stage channel can be established.

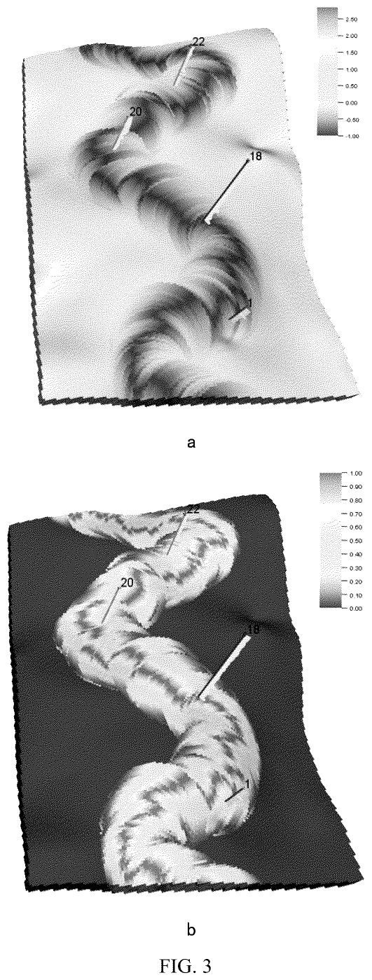

In order to constrain the rule of physical property changes from the center to two sides of the channel, a lateral trend constraint is introduced to establish a lateral trend probability body inside the channel. The initial lateral trend body established by a target-based algorithm characterizes the rule of gradual changes from the center to two sides of the channel, as shown in FIG. 3a. However, the Fluvsim algorithm is used to depict the centerline position of the channel, set a center value of the channel as −1, and make the value progressively increase towards the channel boundary. To constraint the internal physical property trend of the channel, the initial lateral trend body is normalized into a model body within an interval of 0-1. The initial lateral trend body in FIG. 3a is normalized into a lateral trend body with a probability value that is close to 1 in the center of the channel, progressively decreases from the center to the boundary of a sediment body, and is close to 0 at the edge of the channel. As shown in FIG. 3b, the final lateral trend body is used to constrain the distribution rule of sand bodies inside the channel and characterize that the physical properties of the central part of the channel are better and that of two sides are worse. In FIG. 3, labels 22, 20, 18, and 1 represent well positions.

Preferably, in another embodiment of the present application, the step of “S300, establishing a pendant trend body of the underwater distributary channel in the study area by using an internal pendant trend constraint of the single-stage channel in the channel facies model” specifically includes:
obtaining an initial pendant trend body by using the internal pendant trend of the single-stage channel in the channel facies model, where the internal pendant trend of the channel is defined as a rule of gradually fining grain sizes and decreasing physical properties from a bottom to a top of the channel;
normalizing the initial pendant trend body to the pendant trend body of the underwater distributary channel in the study area within a range of [0-1].

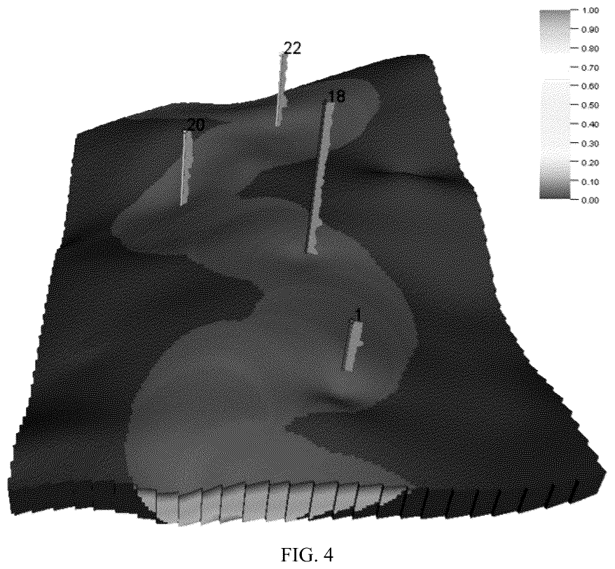

Specifically, in this embodiment, based on the geological rules and the results of previous geological studies, it is known that the channel generally shows a positive rhythm, where reservoirs with good physical properties are distributed at the bottom, and reservoirs with relatively poor physical properties are mostly located in the upper and middle parts of sedimentary cycles. In order to constrain the rule of physical property changes from the top to bottom within the channel, a pendant trend constraint is introduced to establish a pendant trend probability body inside the channel, as shown in FIG. 4. Labels 22, 20, 18 and 1 in FIG. 4 represent well positions. The pendant trend describes a distance relationship between each grid and the top within the channel. The distance from the top of the channel is 0, the distance from the top to the bottom of the channel gradually increases, and the distance from the bottom of the channel is 1, characterizing the trend of internal physical property rules of the channel in a pendant direction.

Preferably, in another embodiment of the present application, the step of “S400, setting different weightings for the lateral trend body and the pendant trend body respectively for multiple times to obtain a fusion trend body corresponding to each weighted fusion” specifically includes:
setting a weighting α for the lateral trend body Pᵢⱼₖ, and setting a weighting β for the pendant trend body Vᵢⱼₖ, a weighted calculation method for the fusion trend body ωᵢⱼₖ being as follows:

$${ω}_{ijk} = α {P}_{ijk} + {BV}_{ijk} ; where$$

$$0 \leq α \leq 1 , 0 \leq β \leq 1 , α + β = 1 ;$$

where
i is positions of grid points in an east-west direction of the trend bodies; j is positions of grid points in a south-north direction of the trend bodies, and k is positions of grid points in a pendant direction of the trend bodies.

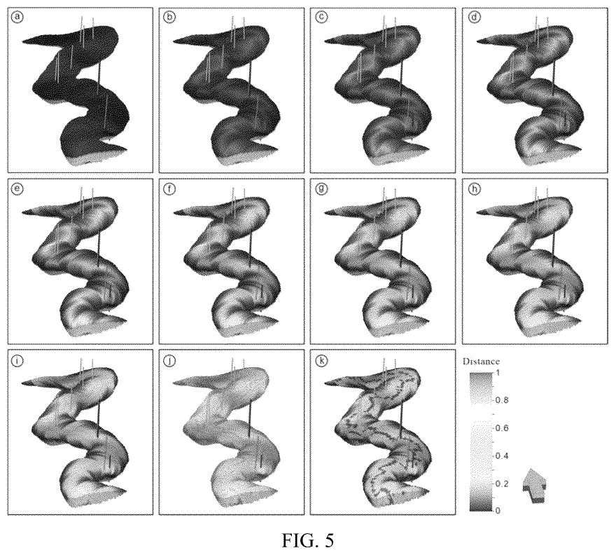

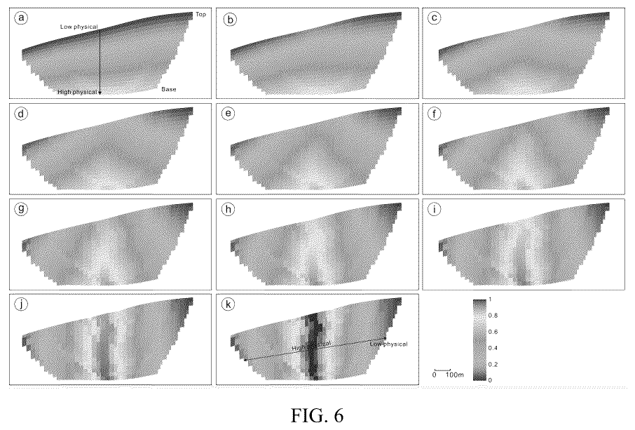

Specifically, in this embodiment, channel facies modeling based on single trend constraint cannot fully reflect the complex and strong heterogeneity characteristics within the channel. Therefore, the rules of geological changes within the channel are taken into account, different weights are set for a planar probability body and a pendant probability body, the probability bodies are fused by weighted addition, and different weightings are assigned to each grid in the model so as to reflect the heterogeneity characteristics within the channel, as shown in FIGS. 5-6.

Given that α and β represent the relative importance in the lateral (planar) and pendant directions, satisfying 0≤α≤1, 0≤β≤1, and α+β=1, then the fusion trend body ωᵢⱼₖ obtained by comprehensively weighting in the two directions is as follows:

$${ω}_{ijk} = α {P}_{ijk} + {BV}_{ijk} , satisfying 0 \leq {ω}_{ijk} 1 ,$$

where
V is the pendant trend body, as shown in FIGS. 5a and 6a; P is the lateral trend body, as shown in FIGS. 5k and 6k; i is positions of grid points in an east-west direction of a work area; j is positions of grid points in a south-north direction of the work area; and k is positions of grid points in a pendant direction of the work area. Therefore, by changing the values of α and β, that is, by changing the proportions in the planar and pendant directions, the comprehensive weighting of any point in the fusion trend body can be changed.

In the fields of reservoir geological modeling and even engineering, i, j, and k usually represent unit vectors in three-dimensional space. In general terms, i, j, and k are unit vectors parallel to x, y, and z axes in a three-dimensional rectangular coordinate system. Typically, i represents the unit length to the right of a horizontal axis, j represents the unit length to the top of a vertical axis, and k points to the unit length in a pendant direction of a plane formed by the horizontal axis and the vertical axis. The position of a point or an object in the three-dimensional space can be accurately defined through these three vectors.

In the process of underground geological modeling of the oil and gas fields, the established model body can reach several kilometers to tens of kilometers in the plane and several meters to hundreds of meters in the pendant direction, causing that the information amount of spatial grid points required for statistical analysis is too large. Generally, due to the limitations of the overall computing power of computers, a step size of 10 m to 200 m is set as a planar step size of a single grid in the plane, a step size of 0.2 m to 5 m is set as a pendant step size of a single grid in a vertical direction, and thus a grid corresponding to an ijk in space is of a cubic shape. However, the accuracy on the step size of the grid depends on the size of the modeling area and the enrichment degree of geological data.

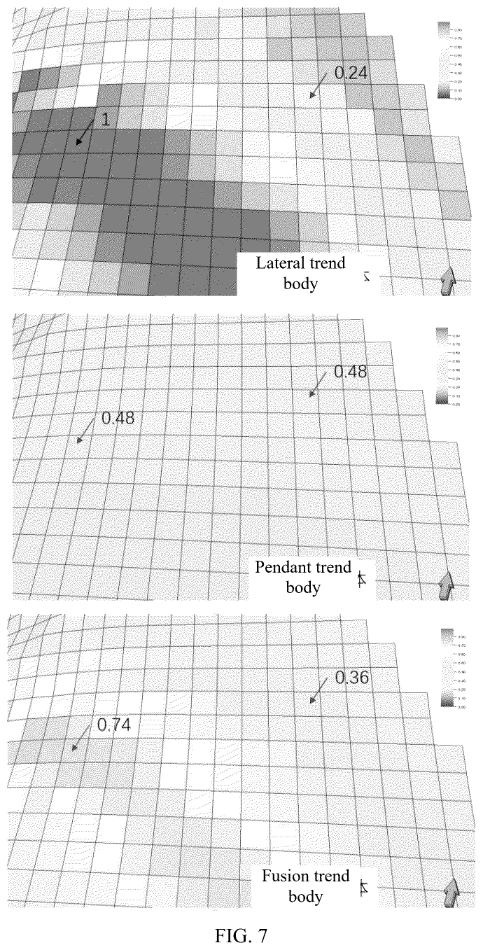

Specifically, in case of α=0 and β=1, a three-dimensional sandstone probability body established based on the comprehensive weight (i.e., the pendant weight) is as shown in FIG. 5a, and the cutting profile of the channel is as shown in FIG. 6a. By taking 0.1 as the step size, gradually increasing the planar weights and decreasing the pendant weights, different fusion trend bodies are obtained sequentially. In case of α=0.1 and β=0.9, a sandstone probability body established based on trend body fusion is as shown in FIG. 5b, and the cutting profile of the channel is as shown in FIG. 6b. In case of α=0.2 and β=0.8, a sandstone probability body established based on trend body fusion is as shown in FIG. 5c, and the cutting profile of the channel is as shown in FIG. 6c. In case of α=0.3 and β=0.7, a sandstone probability body established based on trend body fusion is as shown in FIG. 5d, and the cutting profile of the channel is as shown in FIG. 6d. In case of α=0.4 and β=0.6, a sandstone probability body established based on trend body fusion is as shown in FIG. 5e, and the cutting profile of the channel is as shown in FIG. 6e. In case of α=0.5 and β=0.5, a sandstone probability body established based on trend body fusion is as shown in FIG. 5f, and the cutting profile of the channel is as shown in FIG. 6f. In case of α=0.6 and β=0.4, a sandstone probability body established based on trend body fusion is as shown in FIG. 5g, and the cutting profile of the channel is as shown in FIG. 6g. In case of α−0.7 and β=0.3, a sandstone probability body established based on trend body fusion is as shown in FIG. 5h, and the cutting profile of the channel is as shown in FIG. 6h. In case of α=0.8 and β=0.2, a sandstone probability body established based on trend body fusion is as shown in FIG. 5i, and the cutting profile of the channel is as shown in FIG. 6i. In case of α=0.9 and β=0.1, a sandstone probability body established based on trend body fusion is as shown in FIG. 5j, and the cutting profile of the channel is as shown in FIG. 6j. In case of α=1 and β=0, a sandstone probability body established based on the comprehensive weight, i.e., the lateral (planar) weight, is as shown in FIG. 5k, and the cutting profile of the channel is as shown in FIG. 6k. It should be noted that this embodiment provides the change in the probability values of sand body development at the same grid position for the lateral trend body, the pendant trend body, and the fusion trend body in case of α=0.4 and β=0.6, as shown in FIG. 7.

Preferably, in another embodiment of the present application, the step of “S500, based on porosity data and permeability data in the drilling data, and with all different fusion trend bodies as modeling constraint conditions, obtaining a porosity model and a permeability model of the underwater distributary channel in the study area corresponding to each weighted fusion, respectively” specifically includes:
S510, based on the porosity data in the drilling data, and with all different fusion trend bodies as the modeling constraint conditions, establishing the porosity model of the underwater distributary channel in the study area corresponding to each weighted fusion by using a sequential Gaussian stimulation method; and
S520, based on a positive correlation relationship between the porosity data and the permeability data in the drilling data, and with all different fusion trend bodies and the porosity model as the modeling constraint conditions, establishing the permeability model of the underwater distributary channel in the study area corresponding to each weighted fusion by using the sequential Gaussian stimulation method.

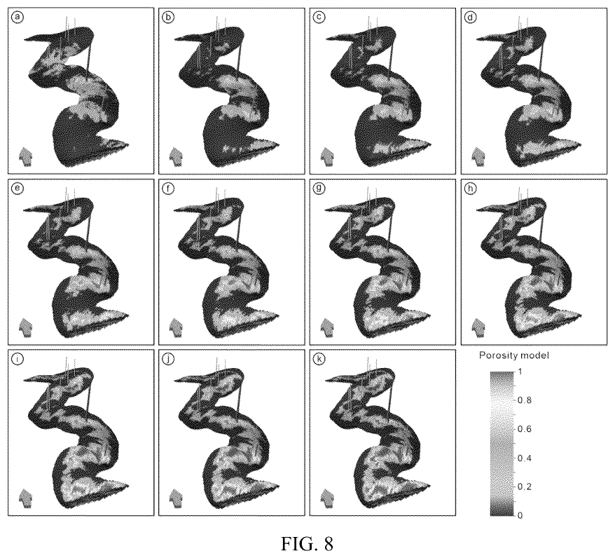

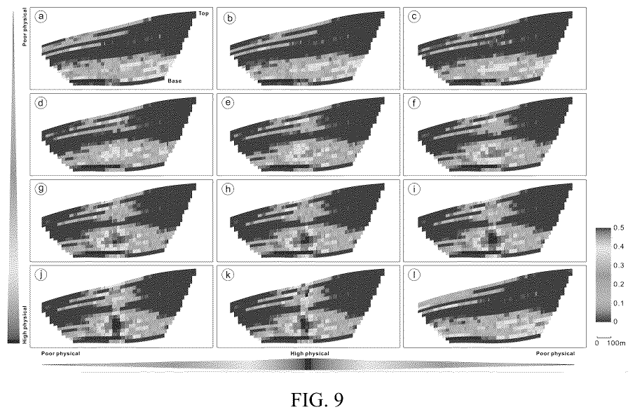

Specifically, in this embodiment, with the porosity data from wellbore condition data as hard data, a physical property model is established by using a combination of deterministic and stochastic modeling strategies through phase control constraints. Mudstone developed in the interchannel facies is a non-oil and gas reservoir. A deterministic modeling method is used to simulate the interchannel facies, and all porosity values of the interchannel facies are set to 0. For the underwater distributary channel facies of dominant reservoirs, the sandstone probability body after fusion of different weights in FIG. 5 is taken as a trend constraint, a porosity model is established by adopting a sequential Gaussian simulation method under phase control, as shown in FIGS. 8-9.

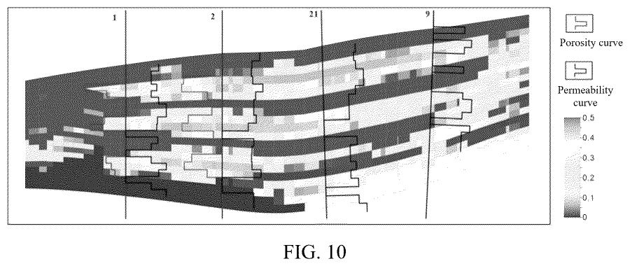

When the pendant weighting is 1, the grids at the bottom of the channel present a higher porosity value, and the porosity value gradually decreases from bottom to top (FIGS. 8a and 9a). As the planar weight increases, the porosity of different sub-layers begins to represent a rule of decreasing from the middle to the edges of the channel in both the plane and the profile (FIGS. 8-9). The fused sandstone probability body exhibits both pendant development rules and planar distribution characteristics (FIGS. 8b-8j and FIGS. 9b-9j). For the channels at different stages or under different sedimentary conditions, the heterogeneity of sand bodies inside the different stages of channels varies depending on factors such as sediment supply, water flow intensity, and channel curvature of the channels. Therefore, based on the actual development rules and geological characteristics of underwater distributary channels at different positions of a delta front reservoir, sandstone probability bodies in different directions can be quantitatively characterized and fused, and a physical property modeling process can be further constrained. For the underwater distributary channels in the study area, a fusion trend body (FIGS. 8f and 9f) with lateral and pendant weightings being 0.5 and 0.5 respectively is selected to constrain a porosity modeling process. The results of models can simulate the internal rhythm and physical property change characteristics of the single-stage channel, showing that the physical property of the bottom of the channel is higher than that of the top, and the physical property of the center of the channel is higher than that of two sides, as shown in FIG. 10.

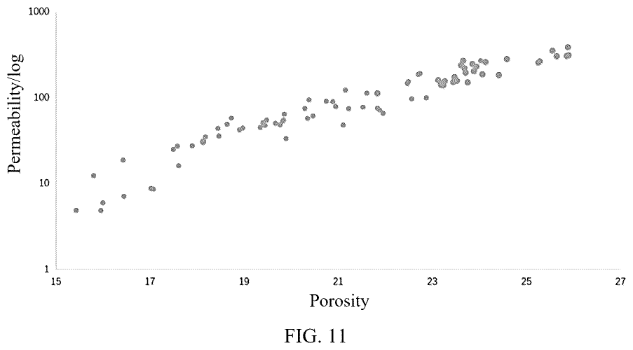

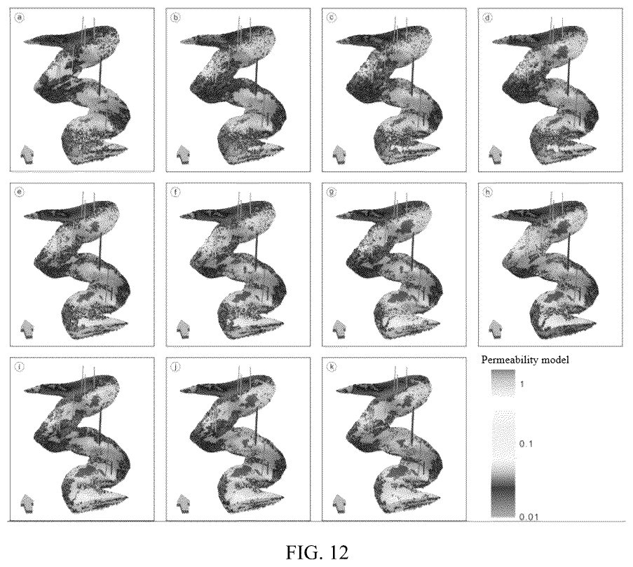

The same method as the aforementioned porosity model is adopted to constrain the modeling process based on the fusion trend bodies under different weight. For the positive correlation relationship between the porosity and permeability of the study area as shown in FIG. 11, the permeability model of the study area is established under the collaborative constraints of the porosity model, and the simulation results are shown in FIG. 12.

Preferably, in another embodiment of the present application, after the step of “S400, setting different weightings for the lateral trend body and the pendant trend body respectively for multiple times to obtain a fusion trend body corresponding to each weighted fusion”, the method specifically includes:
counting a probability distribution of sand body development and an average probability of sand body development of all grids in the fusion trend body corresponding to each weighted fusion to obtain an influence trend of different weightings on the probability distribution of sand body development and the average probability of sand body development.

Specifically, in this embodiment, different lateral and pendant weightings have an influence on the value interval of the probability bodies, as shown in Table 1.

TABLE 1

| | | Probability | | | Average | Average |
|---|---|---|---|---|---|---|
| Planar | Pendant | body intervals | | | porosity | permeability |
| weighting | weighting | Min | Mean | Max | (%) | (mD) |
| 0 | 1 | 0.02 | 0.36 | 0.92 | 17.66 | 145.7 |
| 0.1 | 0.9 | 0.02 | 0.38 | 0.93 | 17.6 | 164 |
| 0.2 | 0.8 | 0.02 | 0.4 | 0.93 | 17.62 | 176.4 |
| 0.3 | 0.7 | 0.01 | 0.42 | 0.94 | 17.67 | 169.5 |
| 0.4 | 0.6 | 0.01 | 0.44 | 0.95 | 17.73 | 174.5 |
| 0.5 | 0.5 | 0.01 | 0.45 | 0.96 | 17.82 | 178.5 |
| 0.6 | 0.4 | 0.01 | 0.47 | 0.97 | 17.88 | 194.4 |
| 0.7 | 0.3 | 0.01 | 0.49 | 0.98 | 17.91 | 189.7 |
| 0.8 | 0.2 | 0 | 0.51 | 0.98 | 17.94 | 201.6 |
| 0.9 | 0.1 | 0 | 0.53 | 0.99 | 17.97 | 191.9 |
| 1 | 0 | 0 | 0.55 | 1 | 17.95 | 212.8 |

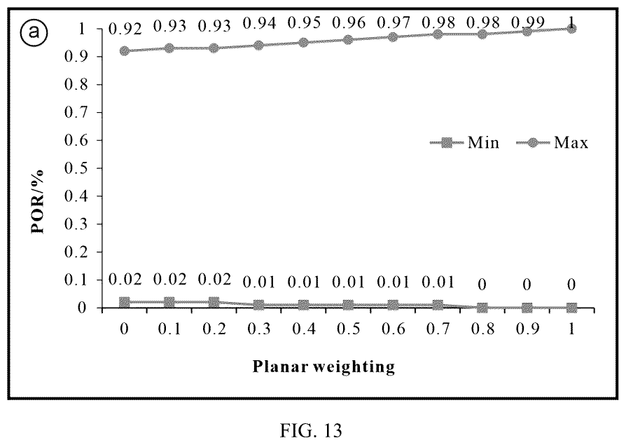

The step size for increasing or decreasing the weightings is set to 0.1. When the planar weighting is 0 and the pendant weighting is 1, an interval of the corresponding fusion probability body is 2%-92%, indicating that the probability distribution of sand body development in all grids inside the underwater distributary channel is between 2%-92%, and an average probability of sand body development in the grids inside the underwater distributary channel is 36%. When the planar weighting is 0.1 and the pendant weighting is 0.9, an interval of the corresponding fusion probability body is 2%-93%, indicating that the probability distribution of sand body development in all grids inside the underwater distributary channel is between 2%-93%, and an average probability of sand body development in the grids inside the underwater distributary channel is 38%. When the planar weighting is 0.2 and the pendant weighting is 0.8, an interval of the corresponding fusion probability body is 2%-93%, indicating that the probability distribution of sand body development in all grids inside the underwater distributary channel is between 2%-93%, and an average probability of sand body development in the grids inside the underwater distributary channel is 40%. When the planar weighting is 0.3 and the pendant weighting is 0.7, an interval of the corresponding fusion probability body is 1%-94%, indicating that the probability distribution of sand body development in all grids inside the underwater distributary channel is between 1%-94%, and an average probability of sand body development in the grids inside the underwater distributary channel is 42%. When the planar weighting is 0.4 and the pendant weighting is 0.6, an interval of the corresponding fusion probability body is 1%-95%, indicating that the probability distribution of sand body development in all grids inside the underwater distributary channel is between 1%-95%, and an average probability of sand body development in the grids inside the underwater distributary channel is 44%. When the planar weighting is 0.5 and the pendant weighting is 0.5, an interval of the corresponding fusion probability body is 1%-96%, indicating that the probability distribution of sand body development in all grids inside the underwater distributary channel is between 1%-96%, and an average probability of sand body development in the grids inside the underwater distributary channel is 45%. When the planar weighting is 0.6 and the pendant weighting is 0.4, an interval of the corresponding fusion probability body is 1%-97%, indicating that the probability distribution of sand body development in all grids inside the underwater distributary channel is between 1%-97%, and an average probability of sand body development in the grids inside the underwater distributary channel is 47%. When the planar weighting is 0.7 and the pendant weighting is 0.3, an interval of the corresponding fusion probability body is 1%-98%, indicating that the probability distribution of sand body development in all grids inside the underwater distributary channel is between 1%-98%, and an average probability of sand body development in the grids inside the underwater distributary channel is 49%. When the planar weighting is 0.8 and the pendant weighting is 0.2, an interval of the corresponding fusion probability body is 0-98%, indicating that the probability distribution of sand body development in all grids inside the underwater distributary channel is between 0-98%, and an average probability of sand body development in the grids inside the underwater distributary channel is 51%. When the planar weighting is 0.9 and the pendant weighting is 0.1, an interval of the corresponding fusion probability body is 0-95%, indicating that the probability distribution of sand body development in all grids inside the underwater distributary channel is between 0-95%, and an average probability of sand body development in the grids inside the underwater distributary channel is 53%. When the planar weighting is 1 and the pendant weighting is 0, an interval of the corresponding fusion probability body is 0-100%, indicating that the probability distribution of sand body development in all grids inside the underwater distributary channel is between 0-100%, and an average probability of sand body development in the grids inside the underwater distributary channel is 55%, as shown in Table 2. In general, as the planar weighting increases and the pendant weighting decreases, an overall development probability value and a probability interval of the sand bodies inside the channel gradually increase. Similarly, an average probability value increases with the increase in the planar weighting, as shown in FIG. 13. Preferably, in another embodiment of the present application, after the step of “S500, based on porosity data and permeability data in the drilling data, and with all different fusion trend bodies as modeling constraint conditions, obtaining a porosity model and a permeability model of the underwater distributary channel in the study area corresponding to each weighted fusion, respectively”, the method specifically includes:
calculating an average porosity of the porosity model of the underwater distributary channel in the study area corresponding to each weighted fusion, and calculating an average permeability of the permeability model of the underwater distributary channel in the study area corresponding to each weighted fusion so as to obtain an influence trend of different weightings on the average porosity and the average permeability, respectively.

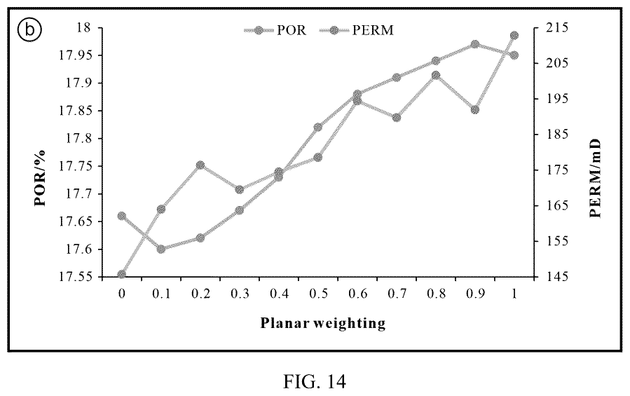

Specifically, in this embodiment, the porosity models under each different weight in FIG. 8 (a total of 11 porosity models) are averaged respectively to obtain the 11 average porosities in FIG. 14. Similarly, the permeability models under each different weight in FIG. 12 (a total of 11 permeability models) are averaged respectively to obtain the 11 average permeabilities in FIG. 14. Due to changes in weights in different directions, the average porosity and permeability of the models generally show an increasing trend, but are not linearly related. This also illustrates that the average porosity and permeability values within the channel are influenced by the weights, but the weights are not the only control factor. In the same delta front subfacies, the interval of internal physical properties of the underwater distributary channels at different positions varies due to the influence of sedimentary environments and hydrodynamic conditions, and the physical property intervals are influenced to different degrees under the control of planar or pendant weights. It should be noted that channels with less curvature, such as the underwater distributary channels, are generally controlled mainly by the influence of pendant trends, while meandering channels with higher curvature are mainly controlled by the influence of planar trends during a river scouring stage.

An embodiment of the present invention further provides a porosity and permeability model system for a delta front channel based on a spatial trend constraint, including:
a data acquisition module, configured to transmit drilling data of an underwater distributary channel in a study area to a PETREL modeling software and establish a channel facies model based on the drilling data;
a lateral trend module in communication connection with the data acquisition module, configured to establish a lateral trend body of the underwater distributary channel in the study area by using an internal lateral trend constraint of a single-stage channel in the channel facies model;
a pendant trend module in communication connection with the data acquisition module, configured to establish a pendant trend body of the underwater distributary channel in the study area by using an internal pendant trend constraint of the single-stage channel in the channel facies model;
a fusion module in communication connection with the lateral trend module and the pendant trend module, configured to set different weightings for the lateral trend body and the pendant trend body respectively for multiple times to obtain a fusion trend body corresponding to each weighted fusion; and
a porosity and permeability construction module in communication connection with the data acquisition module and the fusion module, configured to: based on porosity data and permeability data in the drilling data, and with all different fusion trend bodies as modeling constraint conditions, obtain a porosity model and a permeability model of the underwater distributary channel in the study area corresponding to each weighted fusion, respectively.

Previous studies on the heterogeneity of reservoirs and the distribution rules of sand bodies for the braided river delta fronts have improved the understanding of internal development rules of underwater distributary channels. However, in a traditional process of constructing delta physical property models, methods such as sequential indicator simulation, deterministic modeling, a combination of deterministic modeling and sequential Gaussian simulation, marked point processes, and multi-point geostatistical modeling have been adopted. The limitations of the above-mentioned algorithms are reflected in certain challenges to identify the centerline and boundary positions of the underwater distributary channels, leading to a significant difficulty in establishing internal trend bodies of single-stage channels. Generally, during the use of these algorithms, seismic inversion data, sediment forward modeling, or two-dimensional planar trend surfaces are adopted to constraint models. Results of the models characterize that the rules of internal changes in different directions of different channels and single-stage channels are influenced by the accuracy of constrain data. Therefore, in view of the above problems, according to the present invention, internal heterogeneity characteristics of an underwater distributary channel at different positions in delta front subfacies can be characterized based on a modeling process of multi-directional trend fusion constraints, which provides a scientific basis for the distribution and development decision of remaining oil in channel facies reservoirs of braided river delta fronts.

Specifically, this embodiment corresponds to the above method embodiments one by one, and the functions of each module have been described in detail in the corresponding method embodiments and will not be repeated one by one.

Based on the same inventive concept, the embodiments of the present application further provide a computer-readable storage medium having a computer program stored thereon, where the computer program, when executed by a processor, implements all or part of the method steps of the above method.

The present invention implements all or part of the processes of the above method, and can also be completed by instructing relevant hardware through computer programs. The computer programs can be stored in a computer-readable storage medium, and can implement the steps of the various method embodiments when executed by the processor. Herein, the computer program includes computer program codes, which can be in a form of source codes, object codes, executable files, or some intermediate forms, etc. The computer-readable medium can include: any entity or device capable of carrying the computer program codes, a recording medium, a USB flash drive, a mobile hard disk, a magnetic disc, an optical disc, a computer memory, a read-only memory (ROM), a random access memory (RAM), an electrical carrier signal, a telecommunications signal, a software distribution medium, etc. It should be noted that contents included in the computer-readable medium may be appropriately added or subtracted according to the requirements of legislation and patent practice within judicial districts. For example, in some judicial districts, according to legislation and patent practice, computer-readable media do not include carrier signals and telecommunications signals.

Based on the same inventive concept, an embodiment of the present application further provides an electronic device, including a memory and a processor, where a computer program executable on the processor is stored on the memory, and the processor implements all or part of the method steps of the above method when executing the computer program.

The so-called processor may be a central processing unit (CPU), and may also be other general-purpose processors, a digital signal processor (DSP), an application specific integrated circuit (ASIC), a field-programmable gate array (FPGA) or other programmable logic devices, a discrete gate or a transistor logic device, a discrete hardware component, etc. The general-purpose processor may be a microprocessor or any conventional processor, etc. The processor is a control center of a computer apparatus. Various parts of the entire computer apparatus are connected through various interfaces and lines.

The memory may be used for storing the computer programs and/or modules, and the processor operates or executes the computer programs and/or modules stored in the memory, as well as calls data stored in the memory, to achieve various functions of the computer apparatus. The memory may mainly include a program storage area and a data storage area, where the program storage area may store an operating system, at least one application program required for functions (such as a sound playback function, and an image playback function), etc.; and the data storage area may store data created according to the use of a mobile phone (such as audio data, and video data). In addition, the memory may include a high-speed random access memory, as well as a non-volatile memory such as a hard drive, a memory, a plug-in hard disk, a smart media card (SMC), a secure digital (SD) card, a flash card, at least one disk storage device, a flash device, or other volatile solid-state storage devices.

Those skilled in the art will understand that the embodiments of the present invention may be provided as a method, a system, a server, or a computer program product. Therefore, the present invention may be in the form of a hardware only embodiment, a software only embodiment, or an embodiment with a combination of software and hardware. Moreover, the present invention may be in the form of a computer program product that is implemented on one or more computer-usable storage media (including but not limited to a disk memory, an optical memory, and the like) that include computer-usable program code.

The present invention is described with reference to the flowcharts and/or block diagrams of the method, the device (system), the server, and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Apparently, various modifications and variations to the present invention can be made by those skilled in this art without departing from the spirit and scope of the present invention. Thereby, the present invention intends to encompass all such modifications and variations within the scope of the claims of the present invention and its equivalents.

What is claimed is:

1. A porosity and permeability model method for a delta front channel based on a spatial trend constraint, comprising the following steps:
transmitting drilling data of an underwater distributary channel in a study area to a PETREL modeling software, and establishing a channel facies model based on the drilling data;
establishing a lateral trend body of the underwater distributary channel in the study area by using an internal lateral trend constraint of a single-stage channel in the channel facies model;
establishing a pendant trend body of the underwater distributary channel in the study area by using an internal pendant trend constraint of the single-stage channel in the channel facies model;
setting different weightings for the lateral trend body and the pendant trend body respectively for multiple times to obtain a fusion trend body corresponding to each weighted fusion; and
based on porosity data and permeability data in the drilling data, and with all different fusion trend bodies as modeling constraint conditions, obtaining a porosity model and a permeability model of the underwater distributary channel in the study area corresponding to each weighted fusion, respectively.

2. The porosity and permeability model method for a delta front channel based on a spatial trend constraint according to claim 1, wherein the step of “establishing a channel facies model based on the drilling data” specifically comprises:
based on microfacies data of a delta front sedimentary system in the drilling data, establishing the channel facies model in the study area by using a Fluvsim algorithm.

3. The porosity and permeability model method for a delta front channel based on a spatial trend constraint according to claim 1, wherein the step of “establishing a lateral trend body of the underwater distributary channel in the study area by using an internal lateral trend constraint of a single-stage channel in the channel facies model” specifically comprises:
obtaining an initial lateral trend body by using an internal lateral trend of the single-stage channel in the channel facies model, wherein the internal lateral trend of the channel is defined as a rule of gradually fining grain sizes of sand bodies and decreasing physical properties from a center to two sides of the channel; and
normalizing the initial lateral trend body to the lateral trend body of the underwater distributary channel in the study area within a range of [0-1].

4. The porosity and permeability model method for a delta front channel based on a spatial trend constraint according to claim 1, wherein the step of “establishing a pendant trend body of the underwater distributary channel in the study area by using an internal pendant trend constraint of a single-stage channel in the channel facies model” specifically comprises:
obtaining an initial pendant trend body by using the internal pendant trend of the single-stage channel in the channel facies model, wherein the internal pendant trend of the channel is defined as a rule of gradually fining grain sizes and decreasing physical properties from a bottom to a top of the channel;
normalizing the initial pendant trend body to the pendant trend body of the underwater distributary channel in the study area within a range of [0-1].

5. The porosity and permeability model method for a delta front channel based on a spatial trend constraint according to claim 1, wherein the step of “setting different weightings for the lateral trend body and the pendant trend body respectively for multiple times to obtain a fusion trend body corresponding to each weighted fusion” specifically comprises:
setting a weighting α for the lateral trend body Pijk, and setting a weighting β for the pendant trend body Vᵢⱼₖ, a weighted calculation method for the fusion trend body ωᵢⱼₖ being as follows:
$${ω}_{ijk} = α {P}_{ijk} + {BV}_{ijk} ; wherein$$
$$0 \leq α \leq 1 , 0 \leq β \leq 1 , α + β = 1 , 0 \leq {ω}_{ijk} < 1 ;$$
wherein
i is positions of grid points in an east-west direction of the trend bodies; j is positions of grid points in a south-north direction of the trend bodies, and k is positions of grid points in a pendant direction of the trend bodies.

6. The porosity and permeability model method for a delta front channel based on a spatial trend constraint according to claim 1, wherein the step of “based on porosity data and permeability data in the drilling data, and with all different fusion trend bodies as modeling constraint conditions, obtaining a porosity model and a permeability model of the underwater distributary channel in the study area corresponding to each weighted fusion, respectively” specifically comprises:
based on the porosity data in the drilling data, and with all different fusion trend bodies as the modeling constraint conditions, establishing the porosity model of the underwater distributary channel in the study area corresponding to each weighted fusion by using a sequential Gaussian stimulation method; and
based on a positive correlation relationship between the porosity data and the permeability data in the drilling data, and with all different fusion trend bodies and the porosity model as the modeling constraint conditions, establishing the permeability model of the underwater distributary channel in the study area corresponding to each weighted fusion by using the sequential Gaussian stimulation method.

7. The porosity and permeability model method for a delta front channel based on a spatial trend constraint according to claim 1, wherein after the step of “setting different weightings for the lateral trend body and the pendant trend body respectively for multiple times to obtain a fusion trend body corresponding to each weighted fusion”, the method specifically comprises:
counting a probability distribution of sand body development and an average probability of sand body development of all grids in the fusion trend body corresponding to each weighted fusion to obtain an influence trend of different weightings on the probability distribution of sand body development and the average probability of sand body development.

8. The porosity and permeability model method for a delta front channel based on a spatial trend constraint according to claim 1, wherein after the step of “based on porosity data and permeability data in the drilling data, and with all different fusion trend bodies as modeling constraint conditions, obtaining a porosity model and a permeability model of the underwater distributary channel in the study area corresponding to each weighted fusion, respectively”, the method specifically comprises:
calculating an average porosity of the porosity model of the underwater distributary channel in the study area corresponding to each weighted fusion, and calculating an average permeability of the permeability model of the underwater distributary channel in the study area corresponding to each weighted fusion so as to obtain an influence trend of different weightings on the average porosity and the average permeability, respectively.

9. A porosity and permeability model system for a delta front channel based on a spatial trend constraint, comprising:
a data acquisition module, configured to transmit drilling data of an underwater distributary channel in a study area to a PETREL modeling software and establish a channel facies model based on the drilling data;
a lateral trend module in communication connection with the data acquisition module, configured to establish a lateral trend body of the underwater distributary channel in the study area by using an internal lateral trend constraint of a single-stage channel in the channel facies model;
a pendant trend module in communication connection with the data acquisition module, configured to establish a pendant trend body of the underwater distributary channel in the study area by using an internal pendant trend constraint of the single-stage channel in the channel facies model;
a fusion module in communication connection with the lateral trend module and the pendant trend module, configured to set different weightings for the lateral trend body and the pendant trend body respectively for multiple times to obtain a fusion trend body corresponding to each weighted fusion; and
a porosity and permeability construction module in communication connection with the data acquisition module and the fusion module, configured to: based on porosity data and permeability data in the drilling data, and with all different fusion trend bodies as modeling constraint conditions, obtain a porosity model and a permeability model of the underwater distributary channel in the study area corresponding to each weighted fusion, respectively.

10. A computer-readable storage medium having a computer program stored thereon, wherein the computer program, when executed by a processor, implements the porosity and permeability model method for a delta front channel based on a spatial trend constraint according to claim 1.
